(19) United States
(12) Patent Application Publication
(10) Pub. No.: US 2018/0143013 A1
(43) Pub. Date: May 24, 2018

(54) WHEEL ALIGNMENT MEASUREMENT SYSTEM

(71) Applicants: Mannu ARORA, New Delhi (IN); Pooja ARORA, New Delhi (IN)

(72) Inventors: Mannu ARORA, New Delhi (IN); Pooja ARORA, New Delhi (IN)

(21) Appl. No.: 15/574,484

(22) PCT Filed: May 16, 2016
(86) PCT No.: PCT/IN2016/000125

§ 371 Date: Nov. 15, 2017

(30) Foreign Application Priority Data
May 16, 2015 (IN) 1381/DEL/2015

(51) Int. Cl. G01B 11/275

(52) U.S. Cl. CPC G01B 11/2755; G01B 2210/146; G01B 2210/143

(57) ABSTRACT

The present subject matter relates to a non-contact system to determine alignment of wheels of a vehicle. Such alignment has been achieved by the present invention by providing a method and apparatus for a wheel alignment system to take images on the tyre of the wheel and to align the wheel on the basis of images taken on the tyre.

### FIELD OF THE INVENTION

The present subject matter relates to a non-contact system to determine alignment of wheels of a vehicle.

### BACKGROUND OF THE INVENTION

In this application, the term “wheel” should be understood to include the hub, the spokes or disk of the wheel. It is well known that the wheel is attached to the rim. The rim, at the edge forms the border between the mounted tyre. The middle of the Wheel, Where it normally is mounted to a vehicle's axis is the hub of the Wheel. The portion between the hub and the rim can be spokes of or the disk of the wheel; the area where a spoke merges the rim is the spoke's base.

A wheel along with the rim can be made of an applicable material such as steel, aluminum alloy etc. The tyre is made up of rubber.

Accurate alignment of the wheels of an automotive vehicle is important for both proper handling of the vehicle, as well as proper tyre wear. Alignment of wheels in a vehicle influences cruising characteristics and drivability of the vehicle and are, therefore, important from the viewpoints of riding comfort as well as safety to the passengers. In addition, the proper alignment of the wheels will decrease fuel consumption as well as increase vehicle safety.

In manufacturing and assembly of motor vehicles, wheel alignment quality improvement, such as high accuracy, demands by customers have steadily increased in recent years. Conventional techniques for wheel alignment whether contactless or contact, use the rim to determine the wheel alignment parameters can involve contact with the rim for alignment or contact-less detection of alignment.

In such kind of conventional techniques, the wheel alignment system involves a laser source to incident laser on the wheel and to determine the rim and thus provide wheel alignment parameters.

In another conventional technique, a single laser is incident on the rim intermittently and an image of the rim is captured each time the laser is incident on the rim. Based on triangulation technique, an orientation of the rim is determined from the images. In another similar conventional technique, a plurality of laser lines is incident on the rim and images of the rim captured. In such a technique, one laser line from the plurality of laser lines is faded out and the image is captured, and this is repeated to capture a number of images each with a different line faded out. Further, the alignment of the rim is determined from the images using triangulation techniques. However, such conventional techniques involve capturing a large number of images of the rim which incurs large amount of resources for storing and processing the images. In addition, capturing such a large number of images for wheel alignment, with fading out one laser line each time, can be substantially time consuming.

In addition, capturing such a large number of images of rim have disadvantages as sometimes the images of the rim are not captured properly due to distortion in the rim because of various external factors such as colour and finish of the rim, dust on the rim, size of the rim etc.

In addition, in some cases, the images of the rim cannot be captured properly as the rim may be bent or tapered because of various external factors due to which the procedure of wheel alignment becomes difficult and in some cases, the wheel alignment becomes faulty.

In addition, in some cases, the images of the rim cannot be captured properly because of the limited power of the Laser therefore decreasing the brightness on the overall rim, thus decreasing the accuracy of the final readings.

It is also well known that laser is dangerous to operate and even moderately powered lasers can cause injury to the eye. High power lasers can also burn the skin. Some lasers are so powerful that even the diffuse reflection from a surface can be hazardous to the eye.

Thus, there was a need for a wheel alignment system which does not use laser but retain the high accuracy in the wheel alignment system.

There is a continuing need for a non-contact wheel alignment system which is convenient to use and which provides an improved user interface which can overcome the above mentioned problems.

### OBJECTS OF THE INVENTION

The object of the present invention is to provide a method and apparatus of the kind set forth in the opening part of this specification, with which the alignment of the automotive vehicle wheel can be determined in simplified, compact, accurate, and economical manner.

The other object of the present invention is to provide a method and apparatus for wheel alignment system which can overcome the disadvantages of the prior arts.

The other object of the present invention is to provide a system for synchronizing the operation of the wheel alignment systems to achieve extremely accurate measurements.

The other object of the present invention is to provide a method and apparatus for a wheel alignment system to take images on the tyre of the wheel and to align the wheel on the basis of images taken on the tyre.

### BRIEF DESCRIPTION OF DRAWINGS

FIG. 1 shows the setup of the wheel alignment apparatus in accordance with an embodiment of the present subject matter.

FIG. 2 shows the dismantled setup of the wheel alignment apparatus in accordance with an embodiment of the present subject matter

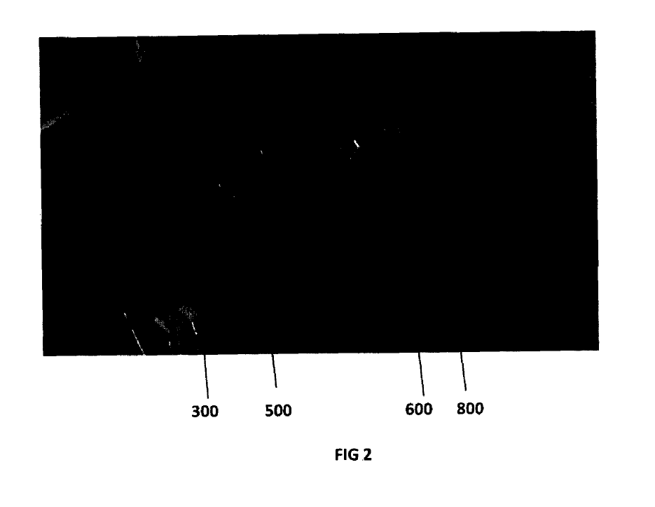

### DESCRIPTION OF THE INVENTION

Conventional techniques for wheel alignment whether contactless or contact, use the rim to determine the wheel alignment parameters can involve contact with the rim for alignment or contact-less detection of alignment. The conventional systems for wheel alignment employ use of optical techniques for detecting a position and orientation of the rim to determine whether the rim is in alignment or not.

It was taught in the conventional techniques that the measurement of the alignment of the rim itself is more reliable for the purpose of adjusting the alignment of the wheels on the vehicle. The inventors, during the alignment process, found that the conventional techniques of the wheel alignment involving the images of the rim had various drawbacks as the images of the rim may not be captured properly due to various due to various external factors like damages, bend, colour (black rim with black tyre is difficult to identify), finish (shiny or mat), dust and grease on the rim, size of the rim etc.

The present invention involves a method for wheel alignment system involving the processing of images by taking the points on the tyre rather than the rim which involves an inventive step over the prior art as the known art described that for wheel alignment the points on tyre may not be reliable and accurate.

Thus, the present subject matter describes a non-contact optical dimensioning device, referred to as wheel alignment system, for measuring alignment of wheels of automotive vehicles. The present subject matter describes systems and methods for aligning wheels of a vehicle. According to an aspect, a plurality of images of a wheel of the vehicle is captured. The plurality of images has been generated from a single light source. Thereafter, based on at least one of the images, a tyre is automatically identified. As will be understood, since the tyre is identified based on the images, and not manually, the same is referred to as being automatically identified. Subsequently, the wheel is aligned based on the identified tyre.

In the present invention, the wheels of the vehicle are stationery during the alignment process. Further, in the specification, the term wheel should be understood as “stationery wheel”.

In another embodiment of the invention, one of the light emitting sources is stationary during the alignment process.

In one embodiment of the invention, the image capturing device is stationery with the stationery components.

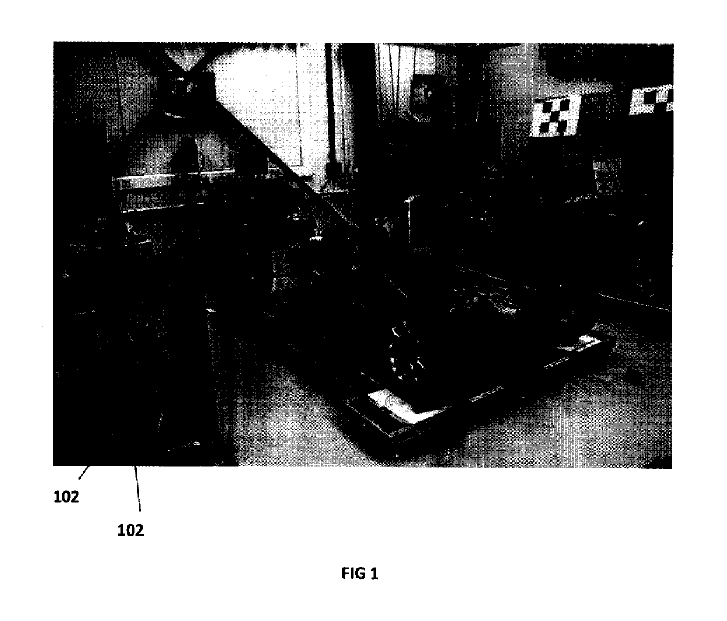

FIG. 1 shows the setup of the wheel alignment system, in accordance with an embodiment of the present subject matter. FIG. 1 discloses a wheel alignment apparatus 100 comprises of a work station 104, plurality of wheel alignment pods 102 and an alignment system 700 for alignment. Wheel alignment pod 102, in an embodiment, comprises of an image capturing device 300, measuring device 400, a light source 500.

The wheel alignment system 100 has a light source 500 to illuminate the wheel 600 of the vehicle for which the alignment is to be carried out, and an image capturing device 300, such as a video camera, to capture image of the tyre 800. In an implementation, one light source 500, and one image capturing device 300 can be provided in the wheel alignment pod 102 for each wheel 600 of the vehicle. In one example, the light source 500 is a light emitting diode (LED).

In one embodiment, the wheel alignment system has one image capturing device 300 for each wheel 600. The spectral response of the image capturing device can also be a consideration while selecting the device. A reasonable response is required that corresponds to the LEDs. In one case, the wheel alignment system can use 4 image capturing devices i.e. one for each wheel.

The wheel alignment pods 102 used in the present invention are non-contact pods and are not connected to the work station 104 unlike the pods which are known in the art. The wheel alignment pod 102 further comprises a high power lithium battery to charge itself. The wheel alignment pods 102 used in the present invention can be classified as front wheel alignment pods 102a and rear wheel alignment pods 102b. In one embodiment, each of the front wheel alignment pods 102a comprises two image capturing devices 300, wherein one image capturing device 300 is equipped to capture the images of the wheel 600 and the second image capturing device 300a which is placed at a side of the wheel alignment pod facing the rear wheel alignment pods 102b is equipped to monitor the rear wheel alignment pods 102b to keep the rear wheel alignment pods 102b in line.

The invention further uses a simple optical system, which substantially reduces both the cost of the equipment and the space required to perform wheel alignment service.

The wheel alignment apparatus 100 as described in the present subject matter involves an image processing of the images to extract Light Emitting Diodes (LEDs) lines projected pattern incident on the tyre 800 and to determine a tyre 800 of the wheel 600. The alignment apparatus 100 uses a light source 500, such as a light emitting diode (LED), which illuminates the wheel 600 and an image capturing device 300 such as camera captures the image of the illuminated tyre 800. Camera device may comprise or include a charged coupled device (CCD) or any other standard camera for receiving the reflected images and converting the images into pixels for analysis by processor. Camera device may have a resolution of 2 megapixel, but may be greater or smaller as desired or required. The camera device may include processing capability, such as by a CPU, and/or a separate processing system located externally from the housing may be utilized to perform mathematical processing. Camera device may also include a narrow band filter that only permits light to pass into camera having wavelengths approximately equivalent to the wavelengths of light output by light emitting source. The image is used to determine axle geometry of the tyre and to ascertain wheel alignment.

The invention further includes a measurement device 400 for calculating the distance of the measurement point on the tyre 800 of the wheel 600 as the working distance of the apparatus can vary based on different factors, including the size of vehicles that the wheel alignment system caters to. For example, the working distance can vary from to 0.9 m to 1.5 m, and in one case, the working distance be selected to be around 1 m. The field of view at 1 m is approximately 0.7 m×0.6 m.

In one embodiment, for measurement of Wheel alignment there is provided a measurement device 400. In the process of alignment, the LED can be directed on to a measurement point located on the surface of a tyre. Further the measurement device 400 comprises a distance measurement device 401 for receiving reflected light from the respective measurement point that originates from the LED. The distance measurement device 401 produces a respective measurement signal that is proportional to the distance of the measurement point to the predetermined and known location of the respective measurement unit as reference location. The system further comprises an alignment module coupled to the processor to align the wheel 600 based on the identified tyre 800.

A system is used to acquire three-dimensional data and a number of innovative methodologies have been developed in order to identify each scanned wheel's features and more importantly to derive its orientation relative to the optical sensor. The orientation of each wheel is then placed in a global coordinate frame relative to the rear axle of the car. The use of image filters, robust and noise immune line fitting and optimization are all designed to alleviate problems caused by variations in lighting levels and inconsistencies in the mode of operation. The wheel alignment system can determine the toe, caster and camber of each wheel.

The present invention involves novel method wherein the alignment system performs the function with the points on the tyre of the wheel which is advantageous because of constant material and colour of tyre instead of varied material and colour of rim.

The present invention involves novel method wherein the alignment system performs the function with the points on the tyre of the wheel so that any kind of the defects of the rim have no effects on the wheel alignment and the alignment system is totally independent of the rim of the wheel.

In the present invention, the wheel alignment system can include a wheel alignment apparatus for identifying, automatically, a tyre of the wheel and for determining a distance of the reference point on the tyre with respect to the image capturing device. The wheel alignment apparatus can execute the following steps with the help a processor—capturing an image of the tyre when the wheel is illuminated by the light source, the image referred to as the LED image. After the image has been captured, the distance measurement device produces a respective measurement signal that is proportional to the distance of the measurement point to the predetermined and known location of the respective measurement unit as reference location. The system then acquires three-dimensional data of the tyre to determine the toe, caster and camber of each wheel to align the wheel based on the identified tyre.

The present invention involves a method having high accurate measurements of the point on the tyre as required for the proper wheel alignment. In some cases, the measuring accuracy required for proper alignment system is 0.03 degree. The system of the present invention is capable to attain said accuracy because of the measurements of the points on the tyre instead of rim.

As will be clear from the foregoing description, the present subject matter facilitates alignment of wheels using non-contact, optical techniques. The automated identification of the tyre precludes the involvement of any manual labour in determining the alignment of the wheels. In addition, the use of the LED image along with the distance measurement device provides a considerably robust and effective manner of determining the alignment of the wheels. For example, the LED projected on the wheel can provide a substantial contrast between the tyre and the wheel and can facilitate in accurately identifying the rim. As a result, accurate alignment of wheels is achieved in accordance with the present subject matter. In addition, the scheme of wheel alignment according to the present subject matter takes into account a large number of reference points located on the bead or angle of the wheel tyre. Such a provision facilitates in substantially accurate and fast determination of alignment of the wheel. In addition, all the reference points are obtained in a single frame of the image and multiple images are not required, further facilitating in fast and convenient determination of the alignment of the wheel.

The operation of the wheel alignment system of the present subject matter is based on the following principles—the wheel alignment system should be capable of determining the orientation of a car wheel, the wheel alignment system should be able to operate with minimal constraints on the environment, and the component cost of the wheel alignment system should be as low as possible. These specifications keep the focus of the wheel alignment system at all times on practicality; in other words, to ensure that the developed system is genuinely useful in a commercial environment.

The present subject matter describes a novel non-contact, LED based wheel alignment system. The wheel alignment system demonstrates the feasibility of non-contact wheel alignment system and offers a major step towards the commercial realization of the wheel alignment system.

Although the subject matter has been described in considerable detail with reference to certain embodiments thereof, other embodiments are possible. It is to be understood that the appended claims are not necessarily limited to the features described herein. Rather, the features are disclosed as embodiments of the wheel alignment system.

I/We claim:

1. A wheel alignment apparatus for detecting the alignment of wheel comprising: a work frame; plurality of wheel alignment pods; and an alignment system to identify, automatically, a tyre coupled to the wheel; and align the wheel based on the identified tyre.

2. The system as claimed in claim 1, further comprises atleast one light source to illuminate the wheel of the vehicle and atleast an image capturing device to capture an image of the tyre.

3. The system as claimed in claim 1, wherein the wheel alignment pods are in non-contact position with work frame.

4. The system as claimed in claim 1, wherein the wheel alignment pods further comprises a measurement device.

5. The system as claimed in claim 1, wherein the wheel is stationery during the alignment process.

6. The system as claimed in claim 2, further comprises one light source and one image capturing device at each wheel of the vehicle.

7. The system as claimed in claim 2, wherein the light source is a light emitting diode (LED).

8. The system as claimed in claim 2, wherein the light emitting source is stationary during the alignment process.

9. The system as claimed in claim 2, wherein the image capturing device is stationery during the alignment process.

10. The system as claimed in claim 1, wherein the wheel alignment pod comprises atleast one image capturing device to capture the image of another wheel alignment pod.

11. A method for aligning wheels of a vehicle, the method comprising: capturing a plurality of images of a stationary wheel of the vehicle; identifying automatically a tyre coupled to the wheel based on the plurality of images; and aligning the wheel based on the identified tyre.

12. The method as claimed in claim 11, wherein the method further comprises identifying one or more measurement points in the tyre for aligning the wheel based on the tyre.

13. A wheel alignment system for wheel alignment comprising: a processor; an image pre-processing module coupled to the processor to obtain a plurality of images from an image capturing device; a measurement device coupled to the processor to automatically identify a tyre coupled to the wheel based on the plurality of captured images; and an alignment module coupled to the processor to align the wheel based on the identified tyre.
